(19) United States
(12) Patent Application Publication
(10) Pub. No.: US 2026/0300767 A1
(43) Pub. Date: Oct. 1, 2026

(54) SYSTEM AND METHOD FOR AI-POWERED REAL-TIME SCREEN SHARING WITH VOICE ASSISTANCE AND SELF-LEARNING MODEL

(71) Applicant: Saswat Kumar Mohanty, Cumming, GA (US)

(72) Inventor: Saswat Kumar Mohanty, Cumming, GA (US)

(21) Appl. No.: 19/544,298

(22) Filed: Feb. 19, 2026

Related U.S. Application Data
(60) Provisional application No. 63/777,031, filed on Mar. 25, 2025.

(51) Int. Cl. G06N 5/022; G10L 13/027; G10L 15/18; G10L 15/22

(52) U.S. Cl. CPC G06N 5/022; G10L 13/027; G10L 15/1815; G10L 15/22

(57) ABSTRACT

An artificial intelligence assistance system integrates real-time screen sharing with voice assistance and self-learning capabilities. The system includes a screen capture module for capturing screen content, a voice recognition module for converting speech to text, and an input management module for processing inputs. A context-aware engine analyzes processed inputs, while an artificial intelligence analysis engine comprising screen analysis, voice analysis, and natural language processing modules extracts relevant information. A knowledge integration module retrieves information from a knowledge repository, and a response generation module formulates responses. The system includes security features such as encryption and role-based access control. A self-learning module continuously updates artificial intelligence models based on user interactions, enabling personalized assistance that adapts to individual user behaviors and preferences over time.

### CROSS-REFERENCE TO RELATED APPLICATION

This application claims the benefit of priority under 35 U.S.C. § 119(e) to U.S. Provisional Patent Application No. 63/777,031, filed Mar. 25, 2025, entitled “SYSTEM AND METHOD FOR AI-POWERED REAL-TIME SCREEN SHARING WITH VOICE ASSISTANCE AND SELF-LEARNING MODEL,” the entire disclosure of which is hereby incorporated by reference herein in its entirety for all purposes.

### FIELD OF THE INVENTION

The present invention relates generally to artificial intelligence systems, and more particularly to a self-learning artificial intelligence system with integrated screen sharing capabilities configured to provide real-time, context-aware assistance to users.

### BACKGROUND OF THE INVENTION

In today's digital landscape, the integration of disparate technologies is becoming increasingly important for enhancing user productivity and interaction. However, existing systems often operate as separate, disconnected entities, leading to fragmented user experiences and operational inefficiencies. Users typically rely on multiple independent applications to achieve seamless communication and technical assistance, which disrupts workflows and reduces overall effectiveness.

Traditional assistance systems face several significant limitations. First, many systems struggle with providing real-time, context-aware feedback, limiting their ability to deliver immediate and relevant support during interactive sessions. When users encounter technical difficulties or need guidance, conventional systems often cannot analyze what the user is actually viewing on their screen in real-time, resulting in generic advice that may not address the specific context of the user's situation.

Second, privacy concerns remain prevalent in existing systems. Continuous monitoring solutions may inadvertently capture sensitive information without adequate security measures, creating risks for users who handle confidential data. The lack of robust encryption and access control mechanisms in many existing platforms compounds these privacy concerns.

Third, the accuracy of recognition technologies presents notable challenges. Many voice recognition systems struggle with understanding diverse accents, dialects, and speech patterns, leading to frequent misinterpretations and user frustration. Similarly, screen analysis capabilities in existing systems may fail to accurately identify and interpret various user interface elements, application states, and on-screen content.

Fourth, the discoverability and usability of user interfaces in existing systems are often suboptimal. Complex systems with multiple features may overwhelm users, making it difficult for them to fully utilize available capabilities. The learning curve associated with existing assistance technologies can discourage adoption and limit effectiveness.

Fifth, existing systems generally lack sophisticated self-learning capabilities. Traditional assistance platforms provide static responses based on pre-programmed rules or limited training data, without adapting to individual user behaviors, preferences, or evolving needs over time. This results in a one-size-fits-all approach that fails to deliver personalized experiences.

These limitations highlight the need for a more cohesive, efficient, and secure solution that can provide real-time, personalized assistance while addressing privacy concerns, improving recognition accuracy, enhancing usability, and incorporating self-learning capabilities to adapt to individual users.

### SUMMARY OF THE INVENTION

The present invention is directed to an integrated artificial intelligence system that combines real-time screen sharing with voice assistance and self-learning capabilities to deliver context-aware, personalized support to users.

In one aspect, the present invention provides a system for AI-powered real-time screen sharing with voice assistance, the system comprising: a user interface module configured to provide interactive elements for user interaction; a screen capture module configured to capture screen content from a user device in real-time; a voice recognition module configured to convert user speech into text; an input management module configured to receive and process inputs from the screen capture module and the voice recognition module; a context-aware engine in communication with the input management module, the context-aware engine configured to analyze processed inputs and generate context-based queries; an artificial intelligence analysis engine comprising a screen analysis module, a voice analysis module, and a natural language processing module, wherein the artificial intelligence analysis engine is configured to process data received from the context-aware engine to extract relevant information and context; a knowledge integration module in communication with the artificial intelligence analysis engine and configured to retrieve information from a knowledge repository; and a response generation module configured to formulate responses based on analysis from the artificial intelligence analysis engine and information from the knowledge integration module.

In another aspect, the system further comprises a self-learning module configured to continuously update artificial intelligence models based on user interactions to enhance personalization of responses.

In yet another aspect, the system further comprises a security layer comprising an authentication module, an encryption module, a role-based access control module, and access control lists, wherein the security layer is configured to provide end-to-end encryption and role-based access control.

In a further aspect, the present invention provides a method for providing AI-powered real-time assistance, the method comprising: capturing screen content from a user device in real-time via a screen capture module; receiving voice input from a user via a voice recognition module; converting the voice input to text using automatic speech recognition; processing the captured screen content and converted text via an input management module; analyzing the processed inputs using a context-aware engine to determine context; processing the context through an artificial intelligence analysis engine comprising screen analysis, voice analysis, and natural language processing; retrieving relevant information from a knowledge repository based on the analysis; generating a response based on the analysis and retrieved information; and presenting the response to the user through a user interface.

In still another aspect, the method further comprises continuously updating artificial intelligence models based on the user interactions to provide increasingly personalized responses over time.

In another aspect, the method further comprises encrypting all data transmissions between components of the system using end-to-end encryption.

In yet another aspect, the system further comprises a knowledge base manager configured to store user-defined artificial intelligence knowledge and domain-specific data for training artificial intelligence models.

In a further aspect, the natural language processing module is configured to interpret transcribed text to discern user intent, context, and nuances to facilitate accurate responses.

In still another aspect, the system further comprises a text-to-speech synthesizer configured to convert textual responses into natural-sounding speech for user playback.

Additional aspects, features, and advantages of the present invention will be apparent from the following detailed description of illustrative embodiments, which is to be read in connection with the accompanying drawings.

### BRIEF DESCRIPTION OF THE DRAWINGS

The accompanying drawings, which are incorporated in and constitute a part of this specification, illustrate embodiments of the invention and, together with the general description given above and the detailed description given below, serve to explain the principles of the invention.

FIG. 1 is a first schematic flow diagram illustrating components of an AI-powered screen sharing system according to an embodiment of the present invention, showing a user interface layer, input capture modules, processing modules, and artificial intelligence analysis components;

FIG. 2 is a second schematic diagram illustrating layered architecture of an AI-powered screen sharing system according to an embodiment of the present invention, showing a user interface layer, core processing layer, artificial intelligence services layer, knowledge management layer, and security layer;

FIG. 3 is a first flow diagram illustrating a method of operation of an AI-powered screen sharing system according to an embodiment of the present invention, showing data flow from user input through processing to response generation; and

FIG. 4 is a second flow diagram illustrating a method of operation of an AI-powered screen sharing system according to an embodiment of the present invention, showing interaction between system components during operation.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims. Various inventive features are described below that can each be used independently of one another or in combination with other features.

Broadly, embodiments of the present invention provide an integrated artificial intelligence system that combines real-time screen sharing capabilities with voice assistance and self-learning functionality to deliver context-aware, personalized support to users. The system addresses limitations in existing assistance technologies by providing seamless integration of multiple input modalities, sophisticated analysis capabilities, robust security measures, and adaptive learning to enhance user experiences over time.

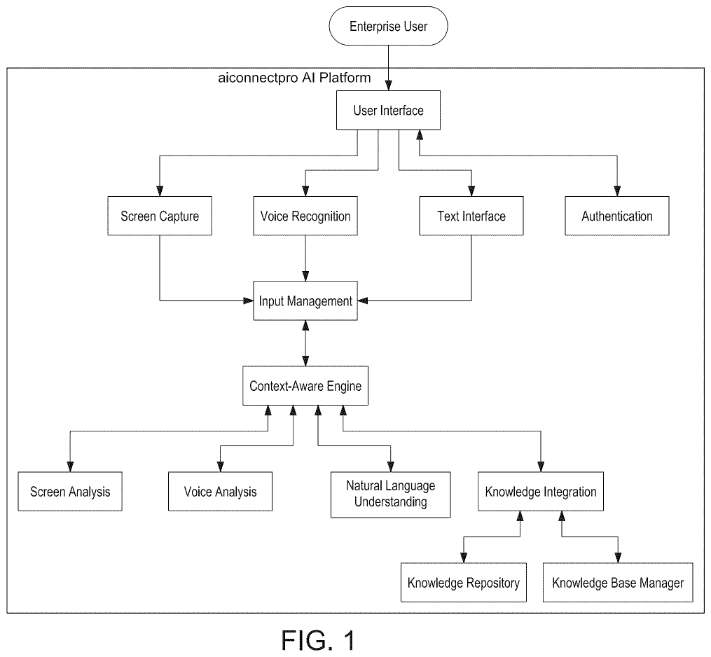

Referring now to FIGS. 1-4, aspects of an AI-powered screen sharing system (referred to herein as “aiconnectpro”) are illustrated and described in detail. The system integrates real-time screen sharing with AI-powered voice assistance, providing users with immediate, context-aware feedback during their tasks. The self-learning AI model adapts to individual user behaviors and preferences, enhancing the personalization and effectiveness of the assistance provided. This integration streamlines user interactions, reduces the need for multiple separate applications, and offers a seamless, efficient, and secure user experience.

### System Architecture Overview

FIG. 1 illustrates a first schematic flow diagram of the system according to an embodiment, including a plurality of interconnected components that work together to provide intelligent assistance. The system can be implemented in one or more computing devices, servers, or distributed computing environments. Users access the system through various interfaces and input modalities, and the system processes user inputs through multiple stages of analysis and interpretation to generate appropriate responses.

### User Interface Layer

A user interface module provides the primary point of interaction between users and the system. The user interface module is configured to provide access to various components and functionalities of the system. In embodiments, the user interface module provides one or more interactive elements for initiating screen sharing sessions, inputting voice commands, entering text queries, viewing responses, and otherwise interacting with the system.

The user interface module can be implemented as a web-based interface accessible through standard web browsers, a dedicated desktop application, a mobile application for smartphones or tablets, or integrated into other software platforms. In certain embodiments, the user interface module can be decoupled from other system components as a standalone component, enabling integration with different platforms or devices. For example, the user interface module can be adapted for use with wearable devices such as smart glasses to provide an immersive experience, allowing users to receive real-time assistance without relying on traditional screens. Alternatively, the user interface module can be integrated into virtual reality or augmented reality environments to provide contextual assistance within immersive experiences.

The user interface module provides access to multiple input mechanisms, including screen capture functionality, voice input capabilities, and text input interfaces. Users can initiate interactions through any of these modalities or combinations thereof, providing flexibility in how they engage with the system.

### Input Capture and Processing

The system includes multiple modules configured to capture different types of user input. A screen capture module is configured to capture and transmit screen content from the user's device in real-time, enabling artificial intelligence models to analyze on-screen content. The screen capture module continuously monitors the user's display and captures visual information including application interfaces, text content, images, error messages, and other displayed elements.

In embodiments, the screen capture module utilizes technologies such as WebRTC (Web Real-Time Communication) for low-latency streaming of screen content. WebRTC provides peer-to-peer communication capabilities that minimize delay in transmitting screen data to analysis components. Alternatively, other protocols such as SIP (Session Initiation Protocol) can be employed for the screen capture module, ensuring compatibility with various network infrastructures and user requirements. The screen capture module can be configured to capture the entire screen, specific application windows, or designated regions of the display based on user preferences or system requirements.

The screen capture module feeds the captured content to artificial intelligence models for further processing and analysis. In certain embodiments, the screen capture module performs preprocessing of captured images, such as resolution adjustment, compression for efficient transmission, or filtering to remove irrelevant visual elements before transmission to analysis components.

A voice recognition module is configured to convert user speech into text, allowing artificial intelligence models to understand verbal commands, queries, questions, and other spoken inputs. User speech can be captured by one or more audio input devices, such as microphones integrated into the user's device, external microphones, headsets, or other audio capture equipment. The captured audio is provided to the voice recognition module through the user interface module.

In embodiments, the voice recognition module converts user speech into text using Automatic Speech Recognition (ASR) technologies. The voice recognition module can utilize integrated application programming interfaces (APIs) such as Google Speech-to-Text, OpenAI's Whisper, or other speech recognition services. These technologies employ sophisticated machine learning models trained on diverse speech datasets to accurately transcribe spoken language into text, accounting for variations in accent, dialect, speech rate, and pronunciation.

The voice recognition module can be configured to operate in real-time, providing immediate transcription as the user speaks, or in batch mode, processing longer segments of recorded audio. In certain embodiments, the voice recognition module includes noise cancellation capabilities to filter out background sounds and improve transcription accuracy. The module can also be configured to identify and distinguish between multiple speakers in multi-user scenarios.

A text interface module is configured to receive textual inputs directly from users for analysis by artificial intelligence models. Users can type queries, commands, or other text-based inputs through the user interface module, which are then processed by the text interface module. This provides an alternative or complementary input mechanism to voice input, accommodating user preferences and situations where voice input may not be practical or preferred.

An authentication module is configured to provide authentication and security services for the system. The authentication module verifies user identities before granting access to system functionalities, ensuring that only authorized users can utilize the system. The authentication module can employ various authentication mechanisms including username and password combinations, multi-factor authentication, biometric authentication (such as fingerprint or facial recognition), token-based authentication, or single sign-on integration with enterprise identity management systems.

### Core Processing Components

An input management module is configured to receive inputs from the user interface module through one or more of the screen capture module, voice recognition module, and text interface module. The input management module serves as a central processing hub that aggregates and coordinates inputs from multiple sources. In embodiments, the input management module performs processing on the received inputs, such as format standardization, data validation, timestamp association, or preliminary filtering.

The input management module processes incoming data streams and prepares them for analysis by downstream components. In certain embodiments, the input management module maintains queues or buffers to handle multiple concurrent inputs, ensuring that all user interactions are properly captured and processed even during periods of high activity. The processed inputs are then provided to a context-aware engine for further analysis.

The context-aware engine is configured to receive processed inputs from the input management module and enhance responses based on contextual information. The context-aware engine analyzes the relationships between different inputs, considers historical interactions, evaluates the current state of the user's environment, and generates context-enriched queries or data structures for artificial intelligence analysis.

In embodiments, the context-aware engine maintains a representation of the current interaction context, including information about the user's current task, the applications being used, recent interactions, and other relevant contextual factors. The context-aware engine uses this contextual information to disambiguate user inputs, prioritize relevant information, and guide subsequent analysis processes. For example, if a user asks: “How do I fix this?” while viewing an error message on their screen, the context-aware engine recognizes that “this” refers to the error message visible in the captured screen content and directs analysis components to focus on that specific error.

### Artificial Intelligence Analysis Engine

The system includes an artificial intelligence analysis engine configured to process data received from the context-aware engine to extract relevant information and context. The artificial intelligence analysis engine comprises multiple specialized modules that analyze different aspects of user inputs and system state.

A screen analysis module is configured to analyze screen content captured by the screen capture module. The screen analysis module processes on-screen elements such as text, images, user interface components, application interfaces, error messages, and other visual content. In embodiments, the screen analysis module employs computer vision techniques and machine learning models to identify and interpret various elements displayed on the screen.

The screen analysis module can perform optical character recognition (OCR) to extract text from images and screenshots, object detection to identify specific user interface elements or visual components, scene understanding to determine the overall context of what is displayed, and anomaly detection to identify errors, warnings, or unusual states. In certain embodiments, the screen analysis module includes specialized models trained to recognize and interpret specific types of applications or interfaces, such as development environments, productivity software, or web browsers.

A voice analysis module is configured to process audio inputs and transcribed text from the voice recognition module. While the voice recognition module converts speech to text, the voice analysis module performs additional analysis on both the audio signals and the resulting text. In embodiments, the voice analysis module can extract prosodic features such as tone, pitch, speaking rate, and emphasis, which can provide insights into user intent, urgency, or emotional state.

The voice analysis module can also perform speaker identification to distinguish between multiple users, detect keywords or phrases that indicate specific types of requests, and analyze speech patterns to improve understanding of user intent beyond the literal meaning of words. This additional layer of analysis enhances the system's ability to respond appropriately to user needs.

A natural language processing (NLP) module is configured to interpret transcribed text and textual inputs to discern user intent, context, and nuances, thereby facilitating accurate responses. The NLP module employs sophisticated language understanding algorithms and models to parse, analyze, and interpret natural language inputs.

In embodiments, the NLP module utilizes advanced language models such as OpenAI's GPT series, BERT, or other transformer-based architectures for robust language understanding. These models can perform tasks including intent classification (determining what the user wants to accomplish), entity extraction (identifying specific items, names, or concepts mentioned), sentiment analysis (understanding the emotional tone), coreference resolution (determining what pronouns and references point to), and semantic parsing (understanding the meaning and relationships within the text).

The NLP module works in conjunction with the context-aware engine to resolve ambiguities, interpret implicit references, and understand the full meaning of user inputs within the current interaction context. In certain embodiments, the NLP module maintains dialogue state tracking capabilities to understand how current inputs relate to previous interactions within an ongoing conversation.

### Knowledge Management Layer

The system includes a knowledge management layer configured to store, organize, and retrieve information relevant to providing assistance to users. A knowledge integration module is configured to manage knowledge integration from a knowledge repository and a knowledge base manager. The knowledge integration module serves as an interface between artificial intelligence analysis components and stored knowledge, facilitating efficient retrieval of relevant information.

In embodiments, the knowledge repository stores various types of information including domain-specific data, technical documentation, troubleshooting guides, best practices, frequently asked questions, and other reference materials. The knowledge repository can be organized using various data structures such as databases, knowledge graphs, document stores, or vector embeddings that enable efficient search and retrieval.

A knowledge base manager is configured to store user-defined artificial intelligence knowledge for context-based assistance. In embodiments, the knowledge base stores domain-specific data provided by users or organizations, allowing the artificial intelligence models to be trained or fine-tuned based on specialized information. This enables the system to provide assistance tailored to specific organizational contexts, proprietary systems, or specialized domains.

Users can populate the knowledge base with documentation, code repositories, internal wikis, training materials, or other relevant information sources. The system can then leverage this custom knowledge when responding to user queries, providing assistance that reflects the specific context and requirements of the user's organization or domain.

A document indexing module is configured to index documents and other content provided to the knowledge base for efficient storage and retrieval. The document indexing module processes documents to extract key information, generate searchable indexes, create vector representations for semantic search, and organize content for rapid retrieval. Indexing techniques can include full-text indexing, semantic embedding, metadata extraction, and hierarchical organization.

A knowledge base integration module is configured to facilitate integration of the knowledge base with other system components. The knowledge base integration module provides interfaces for querying the knowledge base, updating stored information, managing access controls, and synchronizing with external data sources.

In certain embodiments, a knowledge extraction module is configured to extract and provide knowledge from inputs received from the context-aware engine. The knowledge extraction module can identify new information within user interactions that should be added to the knowledge base, extract relevant facts or procedures from ongoing interactions, and update the knowledge base to reflect new insights or information.

### Security Layer

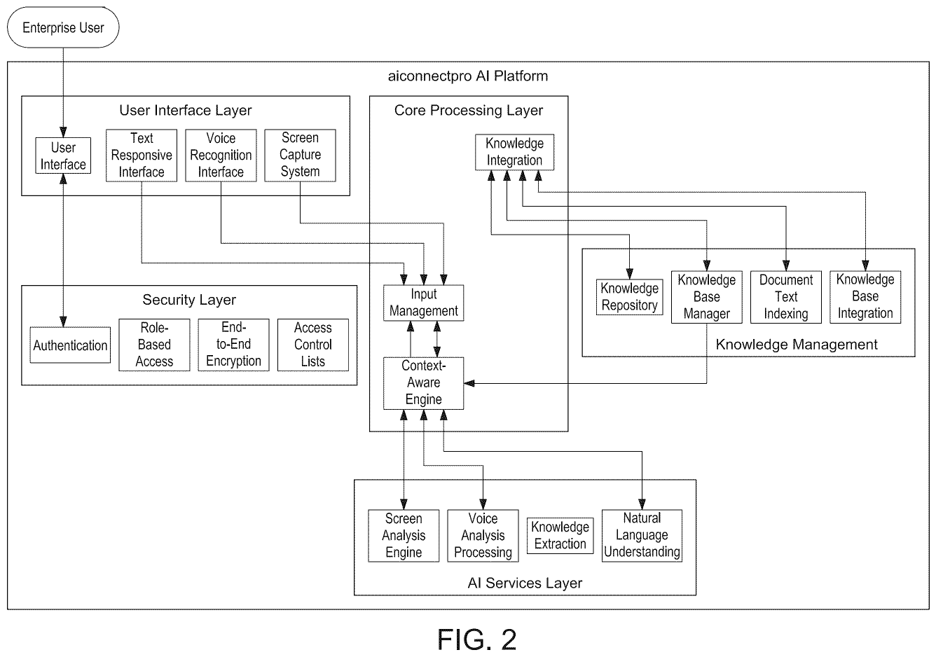

As illustrated in FIG. 2, the system includes a comprehensive security layer configured to protect user data and ensure secure operation. The security layer comprises multiple components working together to provide end-to-end security.

A role-based access control module is configured to utilize access control lists to provide access to system functionalities based on permissions assigned to users according to their roles. Different user roles can have different levels of access to system features, data, or administrative functions. For example, standard users may have access to basic assistance features, while administrators may have access to system configuration, knowledge base management, or user management functions.

The role-based access control module enforces access policies throughout the system, ensuring that users can only access resources and perform actions appropriate to their assigned roles. In certain embodiments, the access control system supports fine-grained permissions that can be customized based on organizational requirements.

An encryption module is configured to provide end-to-end encryption for all data and transmissions within the system. The encryption module ensures that sensitive information, including screen content, voice recordings, text inputs, and responses, are encrypted during transmission and storage. In embodiments, the encryption module employs industry-standard encryption algorithms such as AES (Advanced Encryption Standard) for data at rest and TLS (Transport Layer Security) for data in transit.

The encryption module can implement additional security measures such as key management systems, certificate-based authentication, and secure key exchange protocols. In certain embodiments, the encryption module supports configurable encryption policies that allow organizations to enforce specific security requirements.

Access control lists maintained by the system define specific permissions and restrictions for individual users or groups. These lists can be configured and updated by administrators to reflect organizational policies and security requirements.

### Response Generation and Output

A response generation module is configured to formulate appropriate responses based on analysis from the artificial intelligence analysis engine and information retrieved from the knowledge integration module. The response generation module synthesizes information from multiple sources, including screen analysis results, voice analysis insights, natural language understanding, contextual information, and relevant knowledge from repositories, to generate coherent and helpful responses to user queries or situations.

In embodiments, the response generation module can generate responses in various formats including natural language text, structured data, code snippets, procedural instructions, visual diagrams, or combinations thereof. The response generation module adapts the format and style of responses based on the nature of the user's query and the type of assistance needed.

The response generation module can employ language generation models to produce natural-sounding responses that address user needs comprehensively. In certain embodiments, the response generation module includes citation capabilities to reference sources of information, enabling users to verify or explore information further.

A text-to-speech (TTS) synthesizer is configured to convert textual responses generated by the response generation module into natural-sounding speech for user playback. The TTS synthesizer enables the system to provide auditory feedback, which can be particularly useful when users prefer audio responses, are engaged in hands-free activities, or have visual impairments.

In embodiments, the TTS synthesizer utilizes advanced speech synthesis technologies that produce high-quality, natural-sounding voices with appropriate prosody, intonation, and pacing. The TTS synthesizer can support multiple languages and voice options, allowing users to select preferred voice characteristics.

Responses are presented to users through the user interface module, which can display visual responses on screen, play audio responses through speakers or headphones, or provide responses through other output modalities such as haptic feedback or notifications. The user interface module can format responses appropriately for the display medium, ensuring readability and usability.

### Self-Learning and Adaptation

A self-learning module is configured to continuously update artificial intelligence models based on user interactions to enhance personalization. The self-learning module monitors user interactions, tracks user preferences and behaviors, evaluates response effectiveness, and uses this information to refine and improve system performance over time.

In embodiments, the self-learning module employs machine learning techniques such as reinforcement learning, online learning, or transfer learning to adapt models based on ongoing interactions. When users interact with the system, provide feedback, correct responses, or demonstrate preferences through their behavior, the self-learning module incorporates this information to improve future responses.

The self-learning module can adapt various aspects of system behavior, including response style and format preferences, domain-specific knowledge and terminology, frequent queries or assistance patterns, and personalized shortcuts or assistance strategies. This adaptation occurs at both individual user levels, personalizing experiences for specific users, and at aggregate levels, improving overall system performance based on patterns across multiple users.

In certain embodiments, the self-learning module includes safeguards to prevent overfitting to individual user quirks or reinforcing incorrect behaviors. The module can employ validation techniques, maintain diverse training data, and implement review processes to ensure that learned adaptations improve rather than degrade system performance.

### Additional Supporting Components

The system includes various additional modules configured to support overall operation. A dialog manager maintains the flow of conversation, managing context and ensuring coherent interactions between users and the system. The dialog manager tracks conversation history, manages multi-turn interactions, handles clarification requests, and maintains coherence across extended exchanges.

An internet connectivity module is configured to ensure real-time data transmission between user devices and cloud-based artificial intelligence services. The internet connectivity module manages network connections, handles communication protocols, implements retry logic for failed transmissions, and optimizes data transfer for efficiency and responsiveness.

In certain embodiments, the internet connectivity module can operate in various network conditions, adapting to available bandwidth and handling intermittent connectivity. The module can implement caching or queuing mechanisms to maintain functionality during temporary network disruptions.

### Methods of Operation

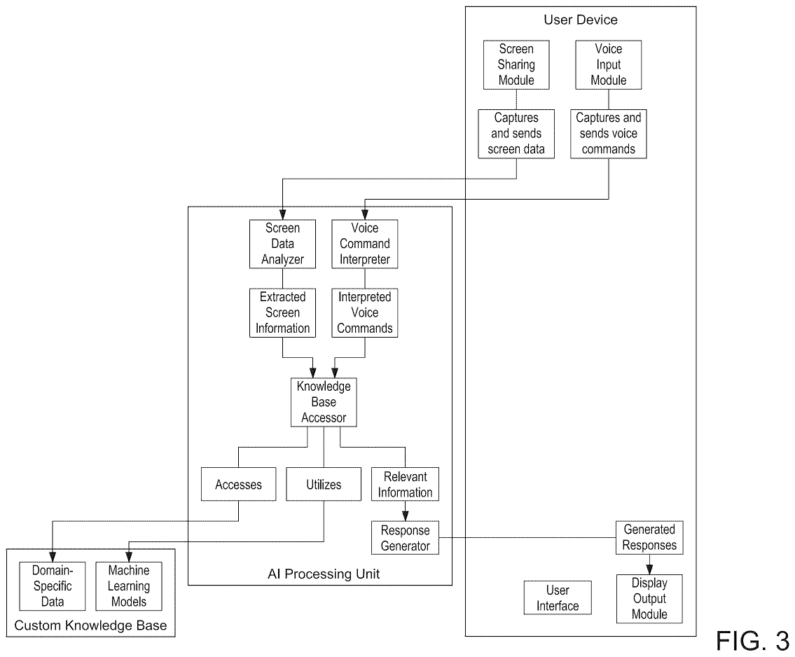

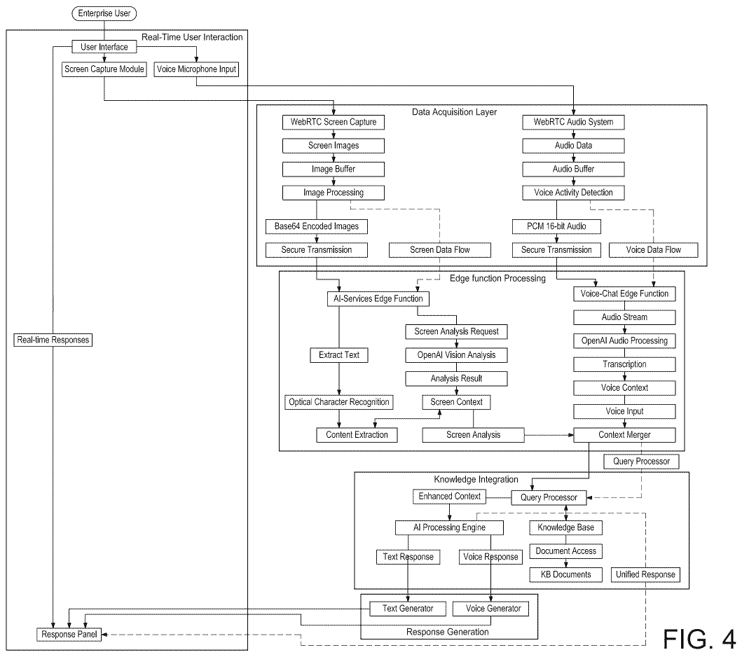

FIGS. 3 and 4 illustrate methods of operation of the system according to embodiments. The methods describe how various system components interact during typical usage scenarios.

In operation, a user initiates interaction with the system through the user interface module by starting a screen sharing session, providing voice input, entering text queries, or combinations thereof. The user interface module activates appropriate input capture modules based on the user's interaction mode.

When screen sharing is initiated, the screen capture module begins capturing screen content in real-time and transmitting captured frames or screen states to the screen analysis module for processing. Simultaneously, if voice input is being used, the voice recognition module captures audio, performs speech-to-text conversion, and provides transcribed text to the voice analysis module and natural language processing module.

The screen analysis module processes screen inputs to extract relevant information such as user interface elements, displayed text, error messages, application states, and visual context. The voice analysis module processes voice inputs to extract prosodic features, speaker characteristics, and other audio-derived information. The natural language processing module interprets textual inputs (from voice transcription or direct text entry) to determine user intent, extract entities, and understand the semantic meaning of user requests.

All extracted information and analysis results are provided to the input management module, which aggregates and coordinates the information. The input management module forwards processed data to the context-aware engine, which integrates information from multiple sources, considers historical context, and generates context-enriched representations of the current interaction state.

The context-aware engine provides this enriched information to the knowledge integration module, which queries the knowledge repository and knowledge base to retrieve relevant information, documentation, procedures, or other knowledge that can assist in responding to the user's needs. The knowledge integration module returns relevant information from knowledge sources.

The response generation module receives analysis results from the artificial intelligence analysis engine and relevant information from the knowledge integration module, then formulates appropriate responses. The response generation module constructs responses that address the user's query or situation, providing explanations, instructions, troubleshooting steps, code examples, or other relevant assistance.

Generated responses are provided to output components for presentation to the user. For visual responses, the user interface module displays the information on the user's screen, which may include formatted text, diagrams, code snippets, or other visual elements. For audio responses, the text-to-speech synthesizer converts response text into speech, which is then played through audio output devices.

Throughout this process, the self-learning module monitors the interaction, tracking user responses to system outputs, noting user preferences or corrections, and recording interaction patterns. This information is used to continuously refine artificial intelligence models, update knowledge bases, and improve future system performance.

The dialog manager maintains conversation state throughout extended interactions, allowing for multi-turn exchanges where subsequent user inputs can reference previous parts of the conversation. When users ask follow-up questions or request clarifications, the dialog manager ensures that context from earlier in the conversation is appropriately considered.

### Implementation Considerations

The system can be deployed in various configurations to suit different use cases and requirements. In cloud-based deployments, core artificial intelligence processing components can be hosted on remote servers, with user devices running lightweight client applications that handle input capture and output presentation. This configuration enables powerful processing capabilities without requiring high-performance hardware on user devices.

In edge computing deployments, certain processing components can be distributed to user devices or local servers to reduce latency, enhance privacy, or support offline operation. Hybrid architectures can combine cloud and edge processing, using local processing for latency-sensitive operations while leveraging cloud resources for complex analysis or knowledge retrieval.

The modular architecture of the system enables customization and extension based on specific requirements. Organizations can integrate custom knowledge sources, implement specialized analysis modules for domain-specific needs, configure security policies and access controls, or integrate with existing enterprise systems.

In embodiments supporting multiple concurrent users, the system can implement resource management and load balancing to efficiently allocate processing resources, handle varying demand levels, and maintain responsive performance. Containerization technologies such as Docker or Kubernetes can facilitate scalable deployment and management.

The system supports integration with various development environments, productivity tools, enterprise applications, and other software platforms, enabling seamless assistance within users' existing workflows. APIs and integration interfaces allow the system to be embedded into other applications or accessed programmatically.

### Technical Advantages

Embodiments of the present invention provide numerous technical advantages over existing systems. The integrated approach combining screen sharing, voice recognition, text input, and artificial intelligence analysis enables more comprehensive and context-aware assistance than systems relying on single input modalities. Users can receive help that considers both what they are seeing on their screens and what they are asking about, resulting in more accurate and relevant responses.

The Self-learning capabilities enable the system to improve over time, adapting to user preferences, organizational contexts, and domain-specific requirements. This adaptive behavior reduces the need for manual configuration and enables increasingly personalized experiences as users continue to interact with the system.

The modular architecture provides flexibility in deployment, enabling organizations to configure the system according to their specific security requirements, infrastructure constraints, and use case needs. Components can be deployed in cloud, edge, or hybrid configurations as appropriate.

The comprehensive security layer, including end-to-end encryption, role-based access control, and authentication mechanisms, addresses privacy concerns inherent in systems that process screen content and voice data. Organizations can deploy the system with confidence that sensitive information is protected.

The integration of multiple artificial intelligence analysis modules (screen analysis, voice analysis, natural language processing) enables sophisticated understanding of user needs. The system can interpret not just what users say or type, but also what they are viewing and doing, providing assistance that considers the full context of the user's situation.

### Alternative Embodiments

While the foregoing description has focused on particular embodiments, various modifications and alternative implementations are possible within the scope of the invention. The specific technologies, protocols, and algorithms mentioned (such as WebRTC, Google Speech-to-Text, GPT models) can be substituted with equivalent or alternative technologies providing similar functionality.

The system architecture can be adapted for specialized use cases, such as customer support applications where agents use the system to assist customers remotely, educational platforms where instructors provide real-time guidance to students, technical support scenarios where IT professionals assist users with software or hardware issues, or collaborative work environments where team members share screens and receive AI-powered insights.

Integration with emerging technologies such as augmented reality, virtual reality, or brain-computer interfaces can extend the system's capabilities and applicability to new domains. The fundamental approach of combining multi-modal input capture, artificial intelligence analysis, context-aware processing, and adaptive learning can be applied across diverse platforms and use cases.

It should be understood, of course, that the foregoing relates to exemplary embodiments of the invention and that modifications may be made without departing from the spirit and scope of the invention as set forth in the following claims.

What is claimed is:

1. An artificial intelligence assistance system comprising:
a screen capture module configured to capture screen content from a user device in real-time;
a voice recognition module configured to convert user speech into text;
an input management module configured to receive and process inputs from the screen capture module and the voice recognition module;
a context-aware engine in communication with the input management module, the context-aware engine configured to analyze processed inputs and maintain contextual information;
an artificial intelligence analysis engine comprising a screen analysis module, a voice analysis module, and a natural language processing module, wherein the artificial intelligence analysis engine is configured to process data received from the context-aware engine;
a knowledge repository configured to store information;
a knowledge integration module in communication with the artificial intelligence analysis engine and the knowledge repository, the knowledge integration module configured to retrieve information from the knowledge repository based on analysis results; and
a response generation module configured to formulate responses based on outputs from the artificial intelligence analysis engine and information from the knowledge integration module.

2. The system of claim 1, further comprising a self-learning module configured to continuously update artificial intelligence models based on user interactions.

3. The system of claim 1, further comprising a user interface module configured to provide interactive elements for initiating screen sharing and displaying responses to a user.

4. The system of claim 1, wherein the screen capture module utilizes WebRTC for low-latency streaming of screen content.

5. The system of claim 1, wherein the voice recognition module employs automatic speech recognition technology to convert the user speech into text.

6. The system of claim 1, further comprising an encryption module configured to provide end-to-end encryption for data transmissions within the system.

7. The system of claim 1, further comprising a role-based access control module configured to enforce access permissions based on user roles.

8. The system of claim 1, further comprising a knowledge base manager configured to store user-defined domain-specific data for training artificial intelligence models.

9. The system of claim 1, wherein the natural language processing module is configured to interpret transcribed text to discern user intent and context.

10. The system of claim 1, further comprising a text-to-speech synthesizer configured to convert textual responses into speech.

11. The system of claim 1, further comprising a text interface module configured to receive textual inputs from the user.

12. The system of claim 1, further comprising a dialog manager configured to maintain conversation flow and manage context across multi-turn interactions.

13. A method for providing real-time artificial intelligence assistance comprising:
capturing screen content from a user device in real-time;
receiving voice input from a user;
converting the voice input to text using automatic speech recognition;
processing the captured screen content and converted text;
analyzing the processed inputs using a context-aware engine to determine contextual information;
processing the contextual information through an artificial intelligence analysis engine comprising screen analysis, voice analysis, and natural language processing capabilities;
retrieving relevant information from a knowledge repository based on the processing;
generating a response based on the processing and retrieved information; and
presenting the response to the user.

14. The method of claim 13, further comprising continuously updating artificial intelligence models based on user interactions to provide personalized responses.

15. The method of claim 13, further comprising encrypting data transmissions between system components using end-to-end encryption.

16. The method of claim 13, wherein the capturing screen content comprises utilizing WebRTC for low-latency streaming.

17. The method of claim 13, further comprising converting the response to speech using a text-to-speech synthesizer and playing the speech to the user.

18. The method of claim 13, further comprising receiving textual input directly from the user through a text interface.

19. The method of claim 13, further comprising authenticating the user before providing access to system functionalities.

20. The method of claim 13, further comprising maintaining dialog state across multiple user interactions to enable coherent multi-turn conversations.
